(19) United States
(12) Patent Application Publication
(10) Pub. No.: US 2013/0227587 A1
(43) Pub. Date: Aug. 29, 2013

(54) METHOD AND APPARATUS FOR CROSS-PROCESS COMMUNICATION, AND COMPUTER STORAGE MEDIUM

(71) Applicants: Libo Deng, Shenzhen (CN); Yi Chen, Shenzhen (CN)

(72) Inventors: Libo Deng, Shenzhen (CN); Yi Chen, Shenzhen (CN)

(21) Appl. No.: 13/882,651

(22) PCT Filed: Oct. 18, 2011
(86) PCT No.: PCT/CN11/80904

§ 371 Date: Apr. 30, 2013

(30) Foreign Application Priority Data
May 11, 2010 (CN) 201010536671.1

(51) Int. Cl. G06F 9/54

(52) U.S. Cl. CPC G06F 9/54
USPC 719/313

(57) ABSTRACT

The present disclosure provides a method and apparatus for cross-process communication, which is related to the field of communication. The method includes: a preset container process receiving a request for cross-process communication sent by a first process; the preset container process setting up a communication channel with the first process according to the request for cross-process communication; the preset container process loading service modules corresponding to the request for cross-process communication, therefore the preset container process that is loaded with the service modules conducting a cross-process communication with the first process through the communication channel. The apparatus includes a reception module, a channel setup module and a loading module. The present disclosure simplifies the process for setting up the communication channel in the cross-process communication, saves codes and therefore improves communication efficiency.

### CROSS-REFERENCE TO RELATED APPLICATIONS

The present application is a US national stage of International Application PCT/CN2011/080904, filed Oct. 18, 2011, and claims foreign priority to Chinese application 201010536671.1 filed Nov. 5, 2010, and which are incorporated herein by reference in their entireties.

### FIELD OF THE INVENTION

The present disclosure relates generally to the field of communication technology, and more particularly, to a method and apparatus for cross-process communication, and computer storage medium.

### BACKGROUND OF THE INVENTION

Cross-process communication refers to transition or exchange of information among different processes. In programs like QQ (an instant messenger software developed by Tencent), Flash or IE (Internet Explorer) services may be used; and therefore cross-process communication between the QQ main process and the Flash process or IE process is required to be launched. Conventional settlement of the cross-process communication is to set up a common memory between the QQ main process and the Flash process, and communicate through reading the common memory.

After analysis of the conventional settlement, it was discovered by the inventors of the present disclosure that at least the following drawback exists:

During the conventional settlement, whenever a cross-process communication is launched, a common memory shall be set up, as the communication channel, between the main process and a destination process; each destination process shall be separately loaded a service module, which causes a waste of the memory capacity.

### SUMMARY OF THE INVENTION

It is provided by embodiments of the present disclosure a method and apparatus for cross-process communication. The technology is as below:

A method for cross-process communication includes:
receiving a request for cross-process communication sent by a first process;
setting up a communication channel with the first process according to the request for cross-process communication;
loading a service module corresponding to the request for cross-process communication; and
conducting a cross-process communication between a preset container process which is loaded with the service module cross-process and the first process through the communication channel.

An apparatus for cross-process communication includes:
a reception module configured to receive a request for cross-process communication sent by a first process;
a channel setup module configured to set up a communication channel with the first process according to the request for cross-process communication;
a loading module configured to load a service module corresponding to the request for cross-process communication; wherein the preset container process that has been loaded with the service module performs cross-process communication with the first process through the communication channel.

A computer storage medium for storing computer executable instructions, said computer executable instructions are configured for controlling the computer to conduct a method for posting updates of the contacts, wherein the method includes:
receiving a request for cross-process communication sent by a first process;
setting up a communication channel with the first process according to the request for cross-process communication;
loading a service module corresponding to the request for cross-process communication; and conducting a cross-process communication between a preset container process which is loaded with the service module cross-process and the first process through the communication channel.

Accordingly, the advantages of the technology provided by the embodiments of the present disclosure are that:
the preset container capable of loading multiple service modules is set up as the entrance; therefore when setting up the cross-process communication channel, it is just needed to set up the communication channel between the communication process and the preset container process, and the corresponding service module is loaded with the preset container process, which simplifies the set up procedure of the cross-process communication process, saves code and improves the communication efficiency.

### BRIEF DESCRIPTION OF THE DRAWINGS

For clearer description of embodiments of the present disclosure or the background technology, a brief introduction to the drawings of the embodiments or the background technology is provided. It is clear that the below described drawings are for exemplary embodiments of the present disclosure, and that those skilled in the art could have other drawings according to the present drawings without requiring creative efforts.

FIG. 1 is a flow chart of a method for cross-process communication according to an embodiment of the present disclosure.

FIG. 2 is a flow chart of a method for cross-process communication according to an embodiment of the present disclosure.

FIG. 3 is a schematic diagram of an apparatus for cross-process communication according to an embodiment of the present disclosure.

FIG. 4 is a schematic diagram of an apparatus for cross-process communication according to an embodiment of the present disclosure.

FIG. 5 is a schematic diagram of an apparatus for cross-process communication according to an embodiment of the present disclosure.

### DESCRIPTION OF THE PREFERRED EMBODIMENTS

For making an objective, technological scheme and advantage of the present disclosure clearer, further detailed description of the present disclosure will be made hereinafter with reference to the drawings.

### Embodiment 1

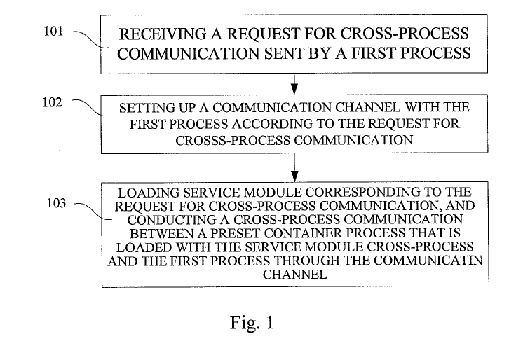

For code economy, an embodiment of the present disclosure provides a method for cross-process communication. Referring to FIG. 1, the method includes:

101: receiving a request for cross-process communication initiated by a first process;

102: setting up a communication channel with the first process according to the request for cross-process communication;

103: loading a service module corresponding to the request for cross-process communication; therefore a preset container process which has been loaded with the service module could be able to carry out the cross-process communication with the first process.

Wherein, before said setting up a communication channel with the first process according to the request for cross-process communication, the following is further included:
detecting if a communication channel exists with the first process; and multiplexing the communication channel if the communication channel exists with the first process; or setting up a communication channel with the first process according to the request for cross-process communication if the communication channel does not exist with the first channel.

Wherein, the setting up a communication channel with the first process according to the request for cross-process communication includes in detail:
picking up a model assigned by the cross-process communication from the request for cross-process communication;
calling the assigned model in the preset container process, and setting up the communication channel between the first process and the preset container process.

Wherein, the preset container process includes a system model, a process model, a session model and a shared model.

The preset container capable of loading multiple service modules is set up as the entrance; therefore when setting up the cross-process communication channel, it is just needed to set up the communication channel between the communication process and the preset container process, and the corresponding service module is loaded with the preset container process, which simplifies the set up procedure of the cross-process communication process, saves code and improves the communication efficiency.

### Embodiment 2

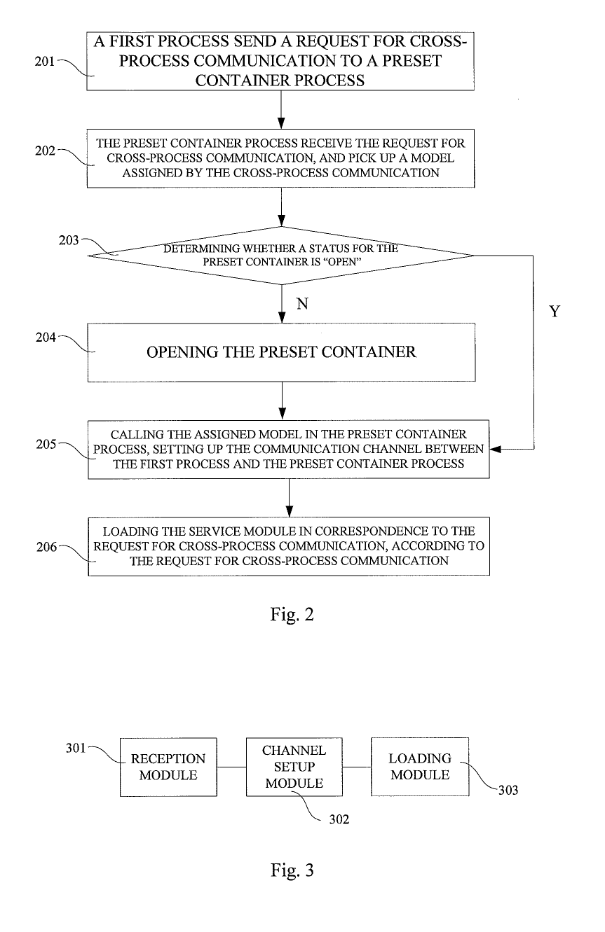

For code economy, an embodiment of the present disclosure provides a method for cross-process communication. The embodiment takes the process that initiates the cross-process communication as the first process, with reference to FIG. 2, and discloses a method that includes:

201: the first process initiates a request for cross-process communication to the preset container process; the request for cross-process communication carries two GUIDs (Globally Unique Identifier) that are dynamically generated by the first process. The two GUIDs include a first process identifier and a second process identifier. The first process identifier is used for identifying the process that initiates the request for cross-process communication; and the second process identifier is used for identifying the destination process of the cross-process communication, that is, the preset container process.

In detail, the two GUIDs function as identifying the processes, and initiating a common memory for the two ends of the cross-process communication. The memory for the communication from the first process to the preset container process is named by the second process identifier GUID, and is shared in common with all the first process. Such memory is allocated by the initiation of the preset container process, and released by the exit of the preset container process. While, the memory for the communication from the preset container process to the first process is privately assigned for the first process. To avoid conflict, the first process transmits the second process identifier GUID to the preset container process through a one-way channel from the first process to the preset container process.

According to an embodiment of the present disclosure, the first process may be various kinds of main processes, such as QQ, IM, etc; while the second process could be the preset container process. It shall be mentioned that, the preset container is a kind of container used for cross-process communication according to the embodiment of the present disclosure. The preset container is used for setting up a communication channel from the process that initiates the communication to the preset container process when a request for cross-process communication is received, and for loading a corresponding service module according to the type of the request.

202: the preset container process receives the request for cross-process communication, and picks up the model assigned by the cross-process communication.

It shall be mentioned that, the preset container process includes a system model, a process model, a session model and a shared model; said model shall be any one or more models of the four models.

203: determining whether the status for the preset container is “open”; carry on step 205 if the status for the preset container is open or step 204 if it is not open.

The method for the determination could be various methods. It could be determined by detecting a service handler or a service process; however, an embodiment of the present disclosure would not be limited on this.

204: opening the preset container.

In detail, after the preset container is launched, it is executed an initiation on the channel from the first process to the preset container, facilitating the followed up set up process of the channel.

205: calling the assigned model in the preset container process, and setting up the communication channel between the first process and the preset container process.

Those skilled in the art would have knowledge that the preset container process includes many kinds of models, for serving different kinds of requests. However, the preset containers have uniform entrances and exits that are codes that have been packaged. The preset container provide a unique entrance for the system; as long as date of the entrance is received and corresponding preset execution according to the data of the entrance, processed data or operation could be output from the uniform data exit.

It could further be included before the step 205: detecting if a communication channel exists between the process that initiates the cross-process communication and the preset container; multiplexing the communication channel if the communication channel exists; or setting up a communication channel between the main process and the preset container according to the type of the request. This step could enable communication through the existing communication channel if there exists the communication channel; while loading the service module, it could be loaded either on the basis of the existing module or the corresponding service module after the existing module is unloaded. The step could omit the setup process of the channel, and further saves codes.

206: loading the service module in correspondence to the request for cross-process communication, according to the request for cross-process communication.

For the service module, the container models are transparent, which kind of container module is executed is not of concern. Preferably, the preset container in detail could be App container, which means that the process for different service modules could be loaded; the process could be able to communicate with the main process of the application program. Each container body could be loaded with one or more service modules, and could be dynamically loaded with service modules accordingly when desires. The service module means Dynamic Link Libraries (DLLs) that could implement particular functions; and the DLLs export entrance functions corresponding to the regulations.

Further, through the above step 201 to 206, after the preset container process that has been loaded with the service modules is able to cross-process communicate with the first process through the communication channel, it is necessary to check the loading situation of the container, which means that the loading situation of the service modules shall be checked to determine whether the service modules corresponding to the request for cross-process communication are loaded. If un-loaded, the service module shall be re-loaded; and the container shall generate identifiers such as conversation ID, and send response to the first process. Consequently, service module export function OnSessionCreate is executed to inform that a new conversation has been set up.

It could be mentioned that, during the execution of the service module, the first process may call a service-waiting handler. If the service process ends up, the first process closes the conversation, and releases an inform event of conversation abnormal break. Upper level applications may determine whether to rebuild the conversation as needed. If there is existed a bug in the service module, each collapse would result in continuous collapse and restart of the service module, further causing the CPU occupancy rate reaches 100%, and affects the user experience. Accordingly, a maximum number of restart could be set, preferably, the number could be 3. Furthermore, the service module has an individual data reception thread; the data is received and broadcasted to the main thread where the business is located. In case the main thread is suspended, the data reception thread may detect. If the detection shows the main thread is suspended, a semaphore could be used for informing the first process; and the first process could accordingly close the conversation and release an inform event of conversation abnormal break. The first process could then determine whether to restart the conversation as needed.

In the above embodiment, the cross-process communication could be share memory communication or Socket communication in detail. If the Socket communication is used, it could be more natural to describe the streaming data communication of the conversation and the one-to-many connection management through the TCP. Wherein, the share memory communication is a kind of data communication executed by a circular queue based on the semaphore and the shared memory, the detailed information is public in the current technology, and would not be described herein.

According to a method as provided in the present disclosure, the preset container capable of loading multiple service modules is set up as the entrance; therefore when setting up the cross- process communication channel, it is just needed to set up the communication channel between the communication process and the preset container process, and the corresponding service module is loaded with the preset container process, which simplifies the set up procedure of the cross-process communication process, saves code and improves the communication efficiency.

### Embodiment 3

For coding economy, it is provided an apparatus for cross-process communications according to an embodiment of the present disclosure. Referring to FIG. 3, the apparatus includes:

Reception module 301, which is configured for receiving a request for cross-process communication sent by the first process;

Channel setup module 302, which is configured for setting up a communication channel with the first process according to the request for cross-process communication;

Loading module 303, which is configured for loading service modules corresponding to the request for cross-process communication; the preset container process that has been loaded with the service modules performs the cross-process communication with the first process through the communication channel.

According to one embodiment, the loading module 303 could further be used for checking the loading situation of the service module, to determine whether the service module corresponding to the request for cross-process communication is loaded. If un-loaded, the service module shall be re-loaded, and the container shall generate conversation ID, and send response to the first process.

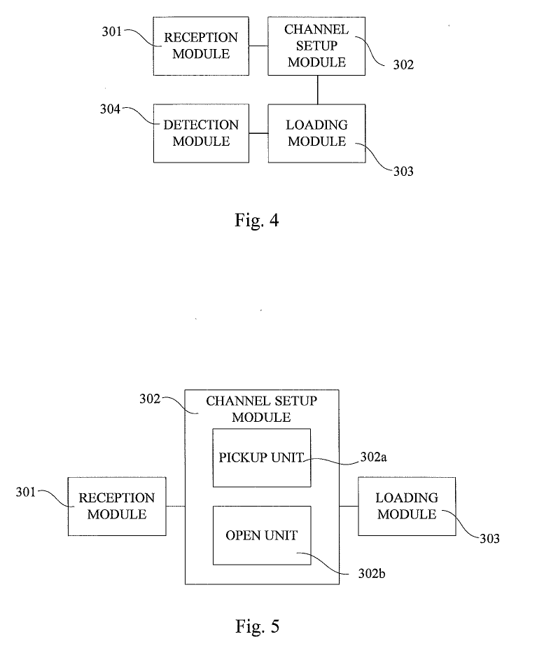

Referring to FIG. 4, the apparatus further includes:

Detection module 304, which is configured for detecting if a communication channel exists with the first process; to multiplex the communication channel if the communication channel exists; or to trigger the channel setup module to set up a communication channel with the first process according to the request for cross-process communication if the communication channel does not exist.

Referring to FIG. 5, the channel set up module 302 includes:

Pickup unit 302a, which is used for picking up a model assigned by the cross-process communication from the request for cross-process communication;

Open unit 302b, which is used for calling the assigned model in the preset container process, and setting up the communication channel between the first process and the preset container process;

According to an embodiment, the open module 302b could further be used for determining whether the status for the preset container is “open”, calling the assigned model in the preset container process and setting up the communication channel between the first process and the preset container process if the status for the preset container is open; or opening the preset container if the status for the preset container is not open.

The preset container process includes a system model, a process model, a session model and a shared model.

According to one embodiment, the cross-process communication could be share memory communication or Socket communication.

The apparatus according to an embodiment of the present disclosure is of the same concept with an embodiment of the method, the detailed information can be found in the description of the embodiments of the method, and will not be described herein.

Whole or part of the technology according to the embodiments of the present disclosure could be carried by corresponding hardware instructed by programs; such program could be stored in readable storage medium which includes various kinds of medium that could store program codes such as ROM, RAM, magnetic disk or optical disk.

It is further provided by the present disclosure a computer storage medium stored with computer executable instructions, while the computer could execute instructions for carrying the above method for posting updates of the contacts.

The foregoing description of the exemplary embodiments is not intended to limit the invention. Any modification, replacement, or improvement within the spirit and principle of the present invention shall be included in the claims.

1. A method for cross-process communication, comprising:
receiving a request for cross-process communication sent by a first process;
setting up a communication channel with the first process according to the request for cross-process communication;
loading a service module corresponding to the request for cross-process communication; and
conducting a cross-process communication between a preset container process which is loaded with the service module and the first process through the communication channel.

2. The method according to claim 1, wherein said conducting the cross-process communication between the preset container process which is loaded with the service module and the first process through the communication channel further comprises:
checking a loading situation of the service module, to determine whether the service module corresponding to the request for cross-process communication is loaded or unloaded; and
if when said checking determines that the service module is unloaded, reloading the service module, generating a conversation ID by a container for loading the service module, and sending response to the first process.

3. The method according to claim 1, wherein before said setting up the communication channel with the first process according to the request for cross-process communication, the method further comprises:
detecting if a communication channel exists or does not exist with the first process;
multiplexing the communication channel when said detecting detects that the communication channel exists with the first process; and
setting up a communication channel with the first process according to the request for cross-process communication when said detecting detects that the communication channel does not exist with the first process.

4. The method according to claim 1, wherein said setting up a communication channel with the first process according to the request for cross-process communication further comprises:
picking up a model assigned by the cross-process communication from the request for cross-process communication;
calling the assigned model in the preset container process; and
setting up the communication channel between the first process and the preset container process.

5. The method according to claim 4, wherein before said calling the assigned model in the preset container process and said setting up the communication channel between the first process and the preset container process, the method further comprises:
determining whether a status for a preset container is open or not open;
executing said calling the assigned model in the preset container process and said setting up the communication channel between the first process and the preset container process when said determining determines that the status for the preset container is open; and
opening the preset container when said determining determines that the status for the present container is not open.

6. The method according to claim 4, wherein the preset container process comprises at least one of a system model, a process model, a session model and a shared model.

7. The method according to claim 1, wherein the cross-process communication is share memory communication or Socket communication.

8. An apparatus for cross-process communication comprising:
a reception module configured to receive a request for cross-process communication sent by a first process;
a channel setup module configured to set up a communication channel with the first process according to the request for cross-process communication; and
a loading module configured to load a service module corresponding to the request for cross-process communication,
wherein a preset container process that has been loaded with the service module performs cross-process communication with the first process through the communication channel.

9. The apparatus according to claim 8, wherein the loading module is further configured to check a loading situation of the service module, to determine whether the service module corresponding to the request for cross-process communication is loaded or unloaded; and
if when it is determined that the service module is unloaded, to reload the service module, to cause a container for loading the service module to generate a conversation ID, and to cause a response to be sent to the first process.

10. The apparatus according to claim 8, wherein the apparatus further comprises:
a detection module configured
to detect if a communication channel exists or does not exist with the first process;
to multiplex the communication channel when it is detected that the communication channel exists; and
to trigger the channel setup module to set up a communication channel with the first process according to the request for cross-process communication when it is detected that the communication channel does not exist.

11. The apparatus according to claim 8, wherein the channel set up module further comprises:
a pickup unit configured to pick up a model assigned by the cross-process communication from the request for cross-process communication;
an open unit configured to call the assigned model in the preset container process, and set up the communication channel between the first process and the preset container process.

12. The apparatus according to claim 11, wherein the open module is configured to
determine whether the status for a preset container is open or not open;
execute said call the assigned model in the preset container process and said set up the communication channel between the first process and the preset container process when it is determined that the status for the preset container is open; and
open the preset container when it is determined that the status for the preset container is not open.

13. The apparatus according to claim 11, wherein the preset container process comprises at least one of a system model, a process model, a session model and a shared model.

14. The apparatus according to claim 8, wherein the cross-process communication is share memory communication or Socket communication.

15. A computer storage medium storing computer executable instructions that, when executed by a computer, cause the computer to perform a process comprising:
receiving a request for cross-process communication sent by a first process;
setting up a communication channel with the first process according to the request for cross-process communication;
loading a service module corresponding to the request for cross-process communication; and
conducting a cross-process communication between a preset container process which is loaded with the service module cross-process and the first process through the communication channel.

16. The computer storage medium according to claim 15, wherein said conducting the cross-process communication between the preset container process which is loaded with the service module and the first process through the communication channel further comprises:
checking a loading situation of the service module, to determine whether the service module corresponding to the request for cross-process communication is loaded or unloaded; and
when it is determined that the service module is unloaded, reloading the service module, causing a container for loading the service module to generate a conversation ID, and causing a response to be sent to the first process.

17. The computer storage medium according to claim 15, wherein before said setting up the communication channel with the first process according to the request for cross-process communication, the process further comprises:
detecting if a communication channel exists or does not exist with the first process;
multiplexing the communication channel when it is detected that the communication channel exists with the first process;
setting up a communication channel with the first process according to the request for cross-process communication when it is detected that the communication channel does not exist with the first process.

18. The computer storage medium according to claim 15, wherein said setting up a communication channel with the first process according to the request for cross-process communication further comprises:
picking up a model assigned by the cross-process communication from the request for cross-process communication;
calling the assigned model in the preset container process; and
setting up the communication channel between the first process and the preset container process.

19. The computer storage medium according to claim 18, wherein before said calling the assigned model in the preset container process and said setting up the communication channel between the first process and the preset container process, the process further comprises:
determining whether a status for a preset container is open or not open;
executing said calling the assigned model in the preset container process and said setting up the communication channel between the first process and the preset container process when it is determined that the status for the present container is open; and
opening the preset container when it is determined that the status of the preset container is not open.

20. The computer storage medium according to claim 18, wherein the preset container process comprises at least one of a system model, a process model, a session model and a shared model.

21. The computer storage medium according to claim 15, wherein the cross-process communication is share memory communication or Socket communication.
